(19) United States
(12) Patent Application Publication
(10) Pub. No.: US 2026/0158916 A1
(43) Pub. Date: Jun. 11, 2026

(54) DISPLAY CONTROL DEVICE AND STORAGE MEDIUM

(71) Applicants: TOYOTA JIDOSHA KABUSHIKI KAISHA, Toyota-shi (JP); DENSO CORPORATION, Kariya-city (JP)

(72) Inventors: Arata TAKADA, Toyota-shi (JP); Shogo Konishi, Nagoya-shi (JP); Tsutomu Hattori, Toyota-shi (JP)

(73) Assignees: TOYOTA JIDOSHA KABUSHIKI KAISHA, Toyota-shi (JP); DENSO CORPORATION, Kariya-city (JP)

(21) Appl. No.: 19/380,303

(22) Filed: Nov. 5, 2025

(30) Foreign Application Priority Data
Dec. 10, 2024 (JP) 2024-215855

(51) Int. Cl. B60K 35/81; B60K 35/28; B60W 50/14; G06V 20/56

(52) U.S. Cl. CPC B60K 35/81; B60K 35/28; B60W 50/14; G06V 20/588; B60K 2360/176; B60K 2360/1868; B60W 2050/146; B60W 2420/403; B60W 2520/10; B60W 2540/18; B60W 2552/30; B60W 2552/53; B60W 2556/40

(57) ABSTRACT

A display control device performs control to display, on a display portion, an image representing a traveling lane that is a lane in which a vehicle travels, and when a speed of the vehicle is equal to or lower than a first threshold value, and also a curvature of the traveling lane is equal to or smaller than a second threshold value, performs control to display a curved portion in the image representing the traveling lane in an uncurved manner.

### CROSS-REFERENCE TO RELATED APPLICATION

This application claims priority to Japanese Patent Application No. 2024-215855 filed on December 10, 2024. The disclosure of the above-identified application, including the specification, drawings, and claims, is incorporated by reference herein in its entirety.

### BACKGROUND

### 1. Technical Field

The present disclosure relates to a display control device and a storage medium.

### 2. Description of Related Art

Japanese Unexamined Patent Application Publication No. 2022-041244 (JP 2022-041244 A) discloses a technology for displaying an image indicating a traveling lane, which is a lane in which a vehicle is traveling, on a display portion. In the technology that is described in JP 2022-041244 A, when the traveling lane is curved, the image representing the traveling lane that is displayed on the display portion is also curved.

### SUMMARY

When a traveling lane curves relatively gently, an occupant of a vehicle visually perceives the traveling lane as being a curving lane. However, in this case, the curvature is actually small, and accordingly at low vehicle speeds, the vehicle can negotiate the curving lane without turning a steering wheel as much as the occupant visually perceives. Accordingly, when an image indicating the traveling lane is displayed on the display portion in a curved manner similar to the traveling lane, discrepancy may occur between the traveling lane as visually perceived by the occupant, and the image showing the traveling lane that is displayed on the display portion. In this case, the occupant of the vehicle may feel uncomfortable.

The present disclosure has been made in consideration of the above circumstances, and an object thereof is to provide a display control device and a display control program that can suppress uncomfortable sensations felt by the occupant of the vehicle.

A display control device according to a first aspect includes a display control unit that performs control to display, on a display portion, an image representing a traveling lane that is a lane in which a vehicle travels, and when a speed of the vehicle is equal to or lower than a first threshold value, and also a curvature of the traveling lane is equal to or smaller than a second threshold value, the display control unit performs control to display a curved portion in the image representing the traveling lane in an uncurved manner.

According to the display control device according to the first aspect, when the speed of the vehicle is equal to or less than the first threshold value and also the curvature of the traveling lane is equal to or smaller than the second threshold value, the curved portion in the image representing the driving lane is displayed in an uncurved manner. Accordingly, difference between the traveling lane as visually perceived by the occupant and the image representing the traveling lane that is displayed on the display portion can be reduced, thereby suppressing the occupant of the vehicle from feeling uncomfortable.

With the display control device of a second aspect, the display control device of the first aspect further includes a determination unit that determines whether the curvature is equal to or smaller than the second threshold value by determining whether a steering angle of a steering wheel is equal or smaller than a third threshold value.

According to the display control device of the second aspect, determination is made regarding whether the curvature of the traveling lane is equal to or less than the second threshold value, by determining whether the steering angle of the steering wheel is equal to or smaller than the third threshold value. This enables the curvature of the traveling lane to be easily determined.

With the display control device of a third aspect, the display control device of the first aspect further includes a determination unit that determines whether the curvature is equal to or smaller than the second threshold value by using map information or an image shot by a camera that shoots the traveling lane.

According to the display control device of the third aspect, whether the curvature of the traveling lane is equal to or smaller than the second threshold value is determined by using the map information or an image shot by the camera that shoots the traveling lane. This enables the curvature of the traveling lane to be easily determined.

With the display control device of a fourth aspect, in the display control device of any one of the first to third aspects, the display control unit does not change a curve appearance of the curved portion in the image representing the traveling lane when speed of the vehicle changes from a state of exceeding the first threshold value to a state of being equal to or lower than the first threshold value, or from the state of being equal to or lower than the first threshold value to the state of exceeding the first threshold value, while the vehicle is traveling in a curved lane of which the curvature is equal to or less than the second threshold value.

According to the display control device of the fourth aspect, when a vehicle is traveling in the curved lane of which the curvature is equal to or smaller than the second threshold value and also the speed of the vehicle changes from the state of exceeding the first threshold value to the state of equal to or less than the first threshold value, or from the state of being equal to or less than the first threshold value to the state of exceeding the first threshold value, the curve appearance of the curved portion in the image representing the traveling lane does not change. This suppresses the display from switching while the vehicle is traveling in the curving lane, and consequently suppressing the occupant of the vehicle from feeling uncomfortable.

A storage medium of a fifth aspect stores a display control program that causes a computer to execute processing of control to display, on a display portion, an image representing a traveling lane that is a lane in which a vehicle travels, and control to display a curved portion in the image representing the traveling lane, in an uncurved manner, when a speed of the vehicle is equal to or lower than a first threshold value, and also a curvature of the traveling lane is equal to or smaller than a second threshold value.

According to the present disclosure, the occupant of the vehicle can be suppressed from feeling uncomfortable.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a front part of a vehicle cabin of a vehicle, in a state of being viewed from a rear side of the vehicle;

FIG. 2 is a block diagram illustrating an example of a hardware configuration of a display control device;

FIG. 3 is a block diagram illustrating an example of a functional configuration of the display control device;

FIG. 4 is a diagram illustrating an example of a display screen;

FIG. 5 is a diagram illustrating an example of the display screen; and

FIG. 6 is a flowchart showing an example of display control processing.

### DETAILED DESCRIPTION OF EMBODIMENTS

Hereinafter, an embodiment for carrying out the present disclosure will be described in detail with reference to the drawings.

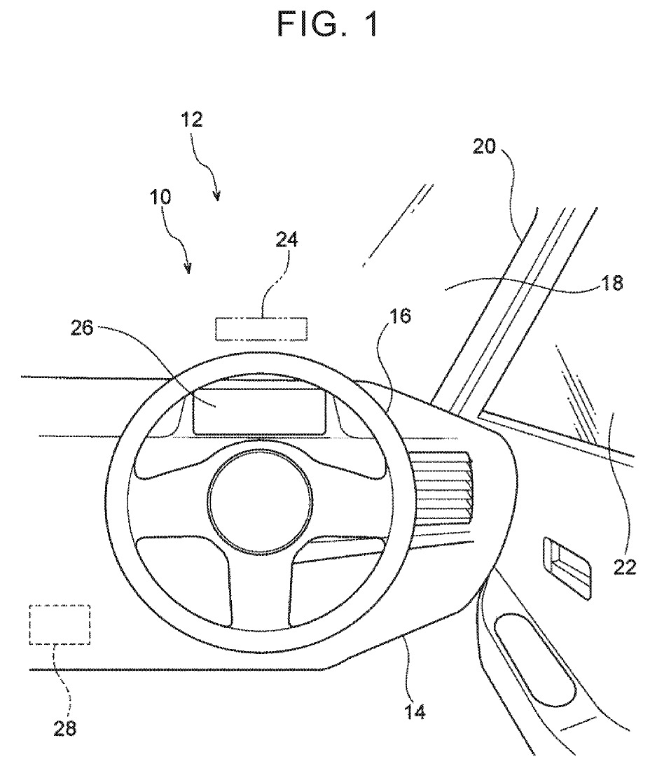

First, with reference to FIG. 1, a configuration of a vehicle 12 to which a display control device 10 according to the present embodiment is applied will be described. As illustrated in FIG. 1, an instrument panel 14 is provided in a front part of a vehicle cabin of the vehicle 12. The instrument panel 14 extends in a vehicle width direction, and a steering wheel 16 is provided on a vehicle right side of the instrument panel 14. That is to say, as an example in the present embodiment, the vehicle is a right-hand drive vehicle with the steering wheel 16 being provided on the right side, and a driver’s seat being provided on the vehicle right side.

A windshield 18 is provided at a front end portion of the instrument panel 14. The windshield 18 extends in a vehicle up-down direction and the vehicle width direction, and separates inside of the vehicle cabin and outside of the vehicle cabin.

A vehicle right-side end portion of the windshield 18 is fixed to a front pillar 20 on the vehicle right side. The front pillar 20 extends in the vehicle up-down direction, and the windshield 18 is fixed to an inner-side end portion of this front pillar 20 in the vehicle width direction. Also, a front end portion of a front side glass 22 is fixed to an outer-side end portion of the front pillar 20 in the vehicle width direction. A vehicle left-side end portion of the windshield 18 is fixed to a front pillar on a vehicle left side, omitted from illustration.

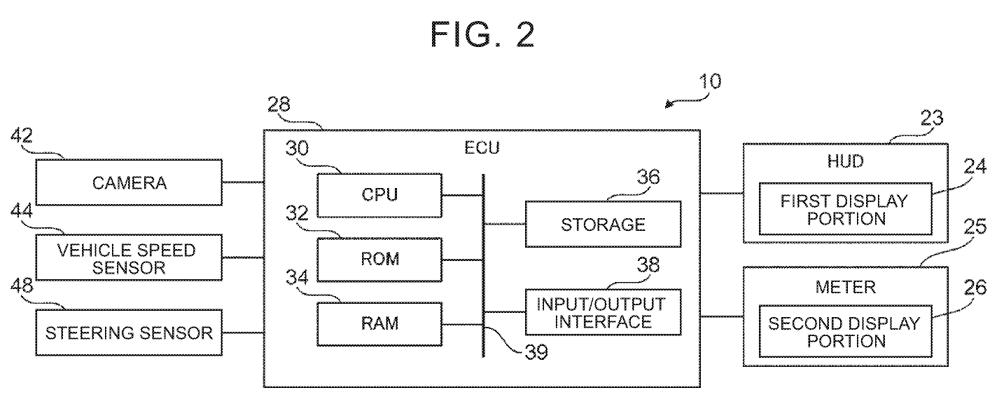

A first display portion 24 is provided on the windshield 18. The first display portion 24 is a head-up display device 23 (see HUD ("head-up display") in FIG. 2), and in FIG. 2 includes a projection surface onto which an image is projected. Specifically, the head-up display device 23 is provided further forward in the vehicle than the instrument panel 14, and is configured to project an image from the head-up display device 23 onto the first display portion 24 on the windshield 18.

A second display portion 26 is provided downward side in the vehicle from the first display portion 24. The second display portion 26 is a display portion that is displayed on a meter 25 (see FIG. 2), and the meter 25 is located forward of the driver's seat in the vehicle, on the instrument panel 14. The first display portion 24 and the second display portion 26 are provided at positions visually perceived by a driver. The second display portion 26 is an example of a display portion according to technology of the disclosure.

A hardware configuration of the display control device 10 will be described with reference to FIG. 2. The display control device 10 is a device that performs control to display situations around the vehicle on the second display portion 26. As illustrated in FIG. 2, the display control device 10 includes an electronic control unit (ECU) 28. The ECU 28 is an example of a computer.

The ECU 28 includes a central processing unit (CPU) 30, read only memory (ROM) 32, random access memory (RAM) 34, storage 36, and an input/output interface (I/F) 38. The CPU 30, the ROM 32, the RAM 34, the storage 36, and the input/output I/F 38 are connected to each other via an internal bus 39 so as to be mutually communicable.

The CPU 30 is a central processing unit that executes various programs, controls each unit, and so forth. That is to say, the CPU 30 reads the programs from the ROM 32 or the storage 36 and executes the programs using the RAM 34 as a work area. The CPU 30 also controls each of the above configurations and performs various types of computation processing in accordance with the programs recorded in the ROM 32 or the storage 36.

The ROM 32 stores various types of programs and various types of data. The RAM 34 serves as a work area, and temporarily stores programs or data. The storage 36 is a non-transitory recording medium made up of a hard disk drive (HDD), a solid state drive (SSD), or flash memory, and stores various types of programs including an operating system, and various types of data. In the present embodiment, the ROM 32 or the storage 36 stores a display control program for performing display control processing, and so forth. Also, various types of input/output devices are connected to the input/output I/F 38.

The ECU 28 is connected to a camera 42, a vehicle speed sensor 44, and a steering sensor 48. The camera 42 is a digital camera that is equipped with an optical system including a lens, a diaphragm, a shutter, and so forth, and an imaging element such as a complementary metal-oxide-semiconductor (CMOS) image sensor, a charge coupled device (CCD) image sensor, or the like. The camera 42 shoots forward from the vehicle 12. The vehicle speed sensor 44 detects speed of the vehicle 12. The steering sensor 48 detects a steering angle of the steering wheel 16.

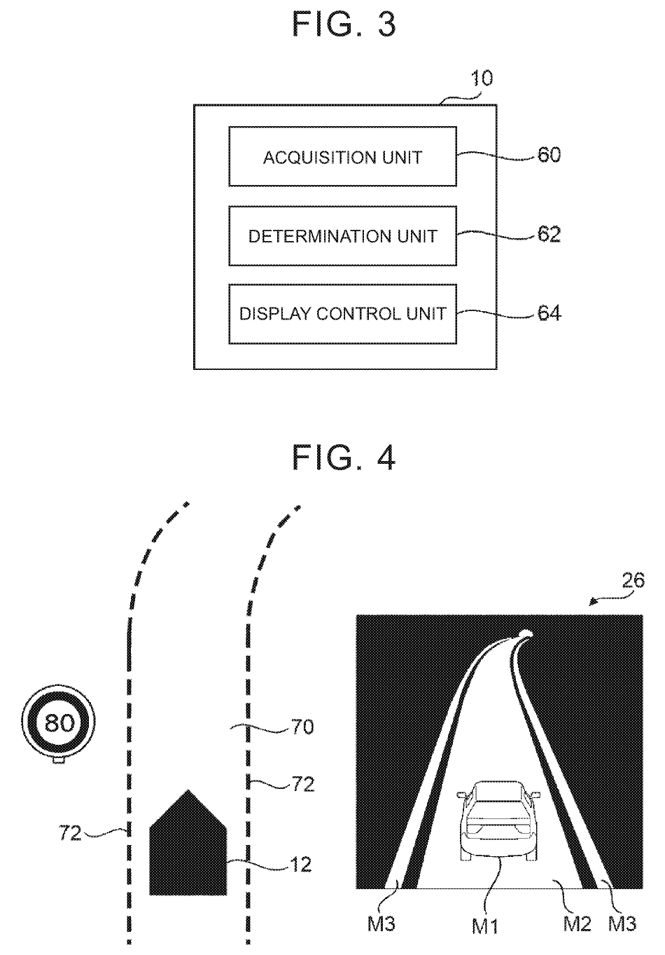

A functional configuration of the display control device 10 according to the present embodiment will be described with reference to FIG. 3. As illustrated in FIG. 3, the display control device 10 includes an acquisition unit 60, a determination unit 62, and a display control unit 64. The CPU 30 executes the display control program that is stored in the ROM 32 or the storage 36 to function as the acquisition unit 60, the determination unit 62, and the display control unit 64.

The acquisition unit 60 acquires the steering angle of the steering wheel 16 that is detected by the steering sensor 48. The acquisition unit 60 also acquires the speed of the vehicle 12 that is detected by the vehicle speed sensor 44.

The determination unit 62 determines whether the speed of the vehicle 12 acquired by the acquisition unit 60 is equal to or lower than a first threshold value. For example, the first threshold value is set in advance through experimentation using an actual vehicle.

The determination unit 62 also determines whether a curvature of a traveling lane that is a lane in which the vehicle 12 is traveling (hereinafter, referred to simply as "traveling lane") is equal to or smaller than a second threshold value. In the present embodiment, the determination unit 62 determines whether the steering angle of the steering wheel 16 that is acquired by the acquisition unit 60 is equal to or smaller than a third threshold value, thereby determining whether the curvature of the traveling lane is equal to or smaller than the second threshold value. For example, the second threshold value is set in advance through experimentation or the like using an actual vehicle. The third threshold value is set in advance, in accordance with the second threshold value.

The display control unit 64 performs control to display an image indicating the traveling lane on the second display portion 26, which is an example of a display portion. In this control, when the determination unit 62 determines that the speed of the vehicle 12 is equal to or lower than the first threshold value, and also the curvature of the traveling lane is equal to or smaller than the second threshold value, the display control unit 64 performs control to display a curved portion in the image indicating the traveling lane in an uncurved manner. In this case, the display control unit 64 according to the present embodiment performs control such that the curved portion in the image indicating the traveling lane is displayed as a straight line without being curved.

Also, when the determination unit 62 determines that the speed of the vehicle 12 exceeds the first threshold value and also the curvature of the traveling lane is equal to or smaller than the second threshold value, the display control unit 64 performs control to display the curved portion in the image indicating the traveling lane in a curved manner. Also, when the curvature of the traveling lane exceeds the second threshold value, the display control unit 64 performs control to display the curved portion in the image indicating the traveling lane in a curved manner.

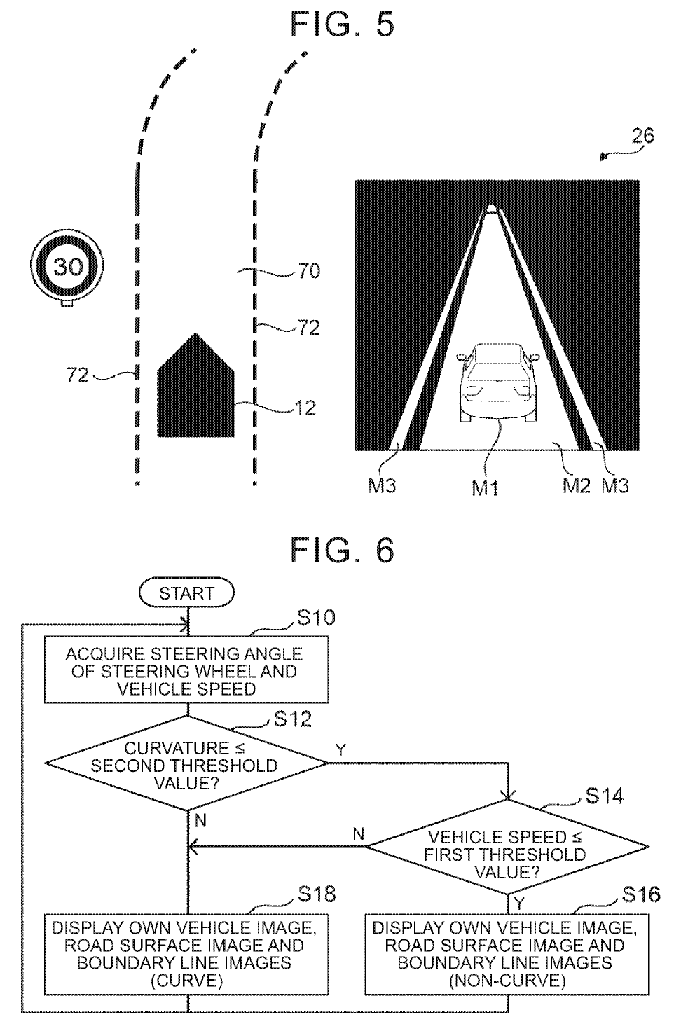

Specific examples of screens that are displayed on the second display portion 26 under the control of the display control unit 64 will be described with reference to FIGS. 4 and 5. In both FIGS. 4 and 5, the left side is a conceptual diagram of a state in which the vehicle 12 is traveling in a traveling lane 70 between left and right boundary lines 72, and the right side is a screen that is displayed on the second display portion 26 corresponding to that state. Also, both FIGS. 4 and 5 represent examples of cases in which the curvature of the traveling lane is equal to or smaller than the second threshold value. Also, FIG. 4 illustrates an example of a case in which the speed of the vehicle 12 exceeds the first threshold value, and FIG. 5 illustrates an example of a case in which the speed of the vehicle 12 is equal to or lower than the first threshold value.

As illustrated in FIGS. 4 and 5, in the present embodiment, an own vehicle image M1 representing the vehicle 12, which is an own vehicle, a road surface image M2 representing a road surface of the traveling lane 70, and boundary line images M3 representing the right and left boundary lines 72 of the traveling lane 70, are displayed on the second display portion 26. The road surface image M2 is an example of an image representing a traveling lane 70.

As illustrated in FIG. 4, when the speed of the vehicle 12 exceeds the first threshold value, the road surface image M2 and the boundary line images M3 are displayed in a curved manner in accordance with the traveling lane 70 and the boundary lines 72. On the other hand, as illustrated in FIG. 5, when the speed of the vehicle 12 is equal to or lower than the first threshold value, the road surface image M2 and the boundary line images M3 are displayed as straight lines.

Operations of the display control device 10 according to the present embodiment will be described with reference to FIG. 6. The CPU 30 executes the display control program stored in the ROM 32 or the storage 36, whereby the display control processing that is shown in FIG. 6 is executed.

In step S10 of FIG. 6, the acquisition unit 60 acquires the steering angle of the steering wheel 16 that is detected by the steering sensor 48 and the speed of the vehicle 12 that is detected by the vehicle speed sensor 44.

In step S12, the determination unit 62 determines whether the steering angle of the steering wheel 16 that is acquired in step S10 is equal to or smaller than the third threshold value, thereby determining whether the curvature of the traveling lane is equal to or smaller than the second threshold. When this determination is a positive determination, the processing transitions to step S14. In step S14, the determination unit 62 determines whether the speed of the vehicle 12 that is acquired in step S10 is equal to or lower than the first threshold value. When this determination is a positive determination, the processing transitions to step S16.

In step S16, the display control unit 64 performs control to display, on the second display portion 26, the own vehicle image M1 representing the vehicle 12, the road surface image M2 representing the traveling lane, and the boundary line images M3 representing the right and left boundary lines of the traveling lane. As described above, in this control, the display control unit 64 performs control to display the road surface image M2 and the boundary line images M3 in an uncurved manner. When the processing of step S16 ends, the processing returns to step S10.

On the other hand, when the curvature of the traveling lane exceeds the second threshold value, the determination in step S12 is a negative determination, and the processing transitions to step S18. Also, when the speed of the vehicle 12 exceeds the first threshold value, the determination in step S14 is a negative determination, and the processing transitions to step S18.

In step S18, the display control unit 64 controls the display on the second display portion 26 of the own vehicle image M1 representing the vehicle 12, the road surface image M2 representing the traveling lane, and the boundary line images M3 representing the right and left boundary lines of the traveling lane. As described above, in this control, the display control unit 64 performs control to display the road surface image M2 and the boundary line images M3 in a curved manner. That is to say, in step S18, the road surface image M2 and the boundary line images M3 are displayed in a curved state in accordance with the curvature of the traveling lane 70. When the processing of step S18 ends, the processing returns to step S10.

As described above, according to the present embodiment, when the speed of the vehicle 12 is equal to or lower than the first threshold value and also the curvature of the traveling lane is equal to or smaller than the second threshold value, the curved portion in the image representing the traveling lane is displayed without being curved. Accordingly, difference between the traveling lane as visually perceived by the occupant and the image representing the traveling lane that is displayed on the second display portion 26 can be reduced, whereby the occupant of the vehicle 12 can be suppressed from feeling uncomfortable.

Note that in the above embodiment, when the vehicle 12 is traveling in a curved lane of which the curvature is equal to or smaller than the second threshold value, and the speed of the vehicle 12 changes from a state exceeding the first threshold value to a state of being equal to or lower than the first threshold value, the display control unit 64 does not need to change the appearance of the curve of the curved portion in the image representing the traveling lane until the vehicle 12 finishes traveling in the curved lane. That is to say, in this case, the display control unit 64 displays the road surface image M2 in a curved state until the vehicle 12 finishes traveling in the curved lane.

Also, in the above embodiment, when the vehicle 12 is traveling in a curved lane of which the curvature is equal to or smaller than the second threshold value, and the speed of the vehicle 12 changes from a state of being equal to or lower than the first threshold value to a state exceeding the first threshold value, the display control unit 64 does not need to change the appearance of the curve of the curved portion in the image representing the traveling lane until the vehicle 12 finishes traveling in the curved lane. That is to say, in this case, the display control unit 64 displays the road surface image M2 as a straight line until the vehicle 12 finishes traveling in the curved lane.

Also, in the above embodiment, the determination unit 62 may use map information to determine whether the curvature of the traveling lane is equal to or smaller than the second threshold value. In this case, for example, the determination unit 62 may identify the traveling lane in the map information by using position information indicating the current position of the vehicle 12.

Also, in the above embodiment, the determination unit 62 may determine whether the curvature of the traveling lane is equal to or smaller than the second threshold value using an image shot by the camera 42 that shoots the traveling lane. For example, the determination unit 62 may recognize the boundary lines of the traveling lane by performing image analysis processing on the image shot by the camera 42. An example of a boundary line is a lane marking such as a white line or the like. In this case, the determination unit 62 may derive the curvature of the traveling lane based on the boundary lines that are recognized, and determine whether the curvature is equal to or smaller than the second threshold value.

Also, a case has been described in the above embodiment regarding the display control unit 64 performing control to display a screen on the second display portion 26, but the disclosed technology is not limited to this form. The display control unit 64 may perform control to display the screen on the first display portion 24, or may perform control to display the screen on the first display portion 24 and the second display portion 26.

Furthermore, the processing in which the CPU reads and executes software (programs) in the above-described embodiment may be executed by various types of processors other than the CPU. In this case, examples of the processors include a programmable logic device (PLD) of which the circuit configuration can be changed after manufacturing, such as a field-programmable gate array (FPGA) or the like, and a dedicated electrical circuit or the like that is a processor having a circuit configuration designed exclusively to execute specific processing, such as an application-specific integrated circuit (ASIC) or the like. Each kind of processing may also be executed by one of these various processors, or may be executed by a combination of two or more processors of the same type or different types (e.g., a plurality of FPGAs, or a combination of a CPU and an FPGA). Also, the hardware configuration of these various types of processors is, more specifically, an electric circuit in which circuit devices or the like, such as semiconductor devices and so forth, are combined.

Further, in the above embodiment, various types of data are stored in the ROM or in the storage, but this is not limiting. For example, a recording medium such as a compact disc (CD), a digital versatile disk (DVD), Universal Serial Bus (USB) memory, or the like, may be used as the storage unit. In this case, various programs, data, and so forth, are stored in these recording media.

The program according to the present disclosure can also be provided as a program product. The program product includes all forms of products for providing programs. For example, the program product includes a program provided via a network such as the Internet or the like, and a non-transitory computer-readable recording medium or the like, such as a CD-ROM, DVD, or the like, in which the program is stored.

Although the vehicle 12 according to the embodiment has been described above, it is needless to say that the present disclosure can be carried out embodied in various forms without departing from the spirit and scope of the present disclosure.

What is claimed is:

1. A display control device comprising a display control unit that performs control to display, on a display portion, an image representing a traveling lane that is a lane in which a vehicle travels, and when a speed of the vehicle is equal to or lower than a first threshold value, and also a curvature of the traveling lane is equal to or smaller than a second threshold value, the display control unit performs control to display a curved portion in the image representing the traveling lane in an uncurved manner.

2. The display control device according to claim 1, further comprising a determination unit that determines whether the curvature is equal to or smaller than the second threshold value by determining whether a steering angle of a steering wheel is equal or smaller than a third threshold value.

3. The display control device according to claim 1, further comprising a determination unit that determines whether the curvature is equal to or smaller than the second threshold value by using map information or an image shot by a camera that shoots the traveling lane.

4. The display control device according to claim 1, wherein the display control unit does not change a curve appearance of the curved portion in the image representing the traveling lane when speed of the vehicle changes from a state of exceeding the first threshold value to a state of being equal to or lower than the first threshold value, or from the state of being equal to or lower than the first threshold value to the state of exceeding the first threshold value, while the vehicle is traveling in a curved lane of which the curvature is equal to or less than the second threshold value.

5. A non-transitory storage medium storing a display control program that causes a computer to execute processing of
control to display, on a display portion, an image representing a traveling lane that is a lane in which a vehicle travels, and
control to display a curved portion in the image representing the traveling lane, in an uncurved manner, when a speed of the vehicle is equal to or lower than a first threshold value, and also a curvature of the traveling lane is equal to or smaller than a second threshold value.
